(19) United States
(12) Patent Application Publication
(10) Pub. No.: US 2025/0233167 A1
(43) Pub. Date: Jul. 17, 2025

(54) LITHIUM-OXYGEN PRIMARY BATTERY

(71) Applicant: PHOENIX BATTERY CORPORATION, HSINCHU CITY (TW)

(72) Inventors: KEVIN IPUTERA, NEW TAIPEI CITY (TW); SHANG-YANG HUANG, KAOHSIUNG CITY (TW); RU-SHI LIU, NEW TAIPEI CITY (TW); SUNG-TING YAO, TAOYUAN CITY (TW)

(21) Appl. No.: 18/662,271

(22) Filed: May 13, 2024

(30) Foreign Application Priority Data
Jan. 12, 2024 (TW) 113101287

(51) Int. Cl. H01M 6/16; H01M 4/02; H01M 4/38; H01M 4/62

(52) U.S. Cl. CPC H01M 6/164; H01M 4/382; H01M 4/622; H01M 4/625; H01M 2004/027; H01M 2004/028

(57) ABSTRACT

A lithium-oxygen primary battery features using a catalyst-free electrolyte. Further, a lithium metal on the negative electrode thereof is decreased to reduce the N/P ratio. Therefore, the lithium-oxygen primary battery of the present invention has a lower cost. The lithium-oxygen primary battery of the present invention has a gravimetric energy density much higher than that of the lithium-oxygen secondary battery.

### BACKGROUND OF THE INVENTION

This application claims priority for the TW patent application no. 113101287 filed on 12 Jan. 2024, the content of which is incorporated by reference in its entirely.

### Field of the Invention

The present invention relates to a lithium-oxygen battery, particularly to a lithium-oxygen primary battery.

### Description of the Prior Art

With the emergence of electric vehicles (EV) and unmanned aerial vehicles (UAV), the industry has paid much attention to batteries. The lithium-ion battery has become the mainstream of the storage batteries. Although the lithium-ion battery can satisfy the operation of electric vehicles and unmanned aerial vehicles, it is still insufficient in energy density. The gravimetric energy density of the traditional lithium-ion battery is about 300 Wh/kg. In order to increase the endurance of EV and UAV, the industry proposed a lithium-oxygen battery (also called the lithium-air battery), which has higher energy density. The energy density of the lithium-oxygen battery is three or more times that of the traditional lithium-ion battery.

At present, the existing lithium-oxygen batteries are secondary batteries. In order to charge and discharge the lithium-oxygen secondary battery repeatedly, a catalyst is added to the electrolyte of the lithium-oxygen secondary battery. Besides, the negative electrode capacity of the lithium-oxygen secondary battery needs to be increased to prevent the high-activity lithium metal on the negative electrode from depleting too fast. Accordingly, the N/P (Negative/Positive) ratio of the current lithium-oxygen battery is greater than 10, wherein the N/P ratio is the ratio of the negative electrode capacity to the positive electrode capacity. The method to increase the negative electrode capacity is increasing the amount of lithium metal. However, both the lithium metal and the catalyst are expensive. Therefore, the lithium-oxygen secondary battery has a higher cost.

Further, in order to increase the service life of a lithium-oxygen battery, i.e., raise the number of charge/discharge operations of the lithium-oxygen battery, the capacity of the lithium-oxygen battery is limited to a smaller value. While the current density is at 100 mA/g, the capacity of the existing lithium-oxygen battery is only about 1000-2000 mAh/g.

### SUMMARY OF THE INVENTION

One objective of the present invention is to propose a lithium-oxygen primary battery.

According to one embodiment, the lithium-oxygen primary battery of the present invention comprises a positive electrode, a negative electrode, and a catalyst-free electrolyte, wherein the catalyst-free electrolyte is between the positive electrode and the negative electrode. The lithium-oxygen primary battery of the present invention features using a catalyst-free electrolyte, whereby the amount of lithium metal on the negative electrode can be decreased to reduce the N/P ratio. Therefore, the lithium-oxygen primary battery of the present invention has a lower cost than the current lithium-oxygen secondary battery. Further, the lithium-oxygen primary battery of the present invention has a higher gravimetric energy density.

### BRIEF DESCRIPTION OF THE DRAWINGS

FIG. 1 is a schematic diagram showing a lithium-oxygen primary battery according to one embodiment of the present invention.

FIG. 2 is a diagram showing the results of the electrochemical experiments of the lithium-oxygen primary battery shown in FIG. 1.

### DETAILED DESCRIPTION OF THE INVENTION

The present invention redesigns a lithium-oxygen battery, which functions as a secondary battery, to be a primary battery, whereby it achieves a higher gravimetric energy density. Accordingly, the lithium-oxygen primary battery of the present invention can provide far more electricity than the conventional lithium-oxygen secondary battery in a single discharge.

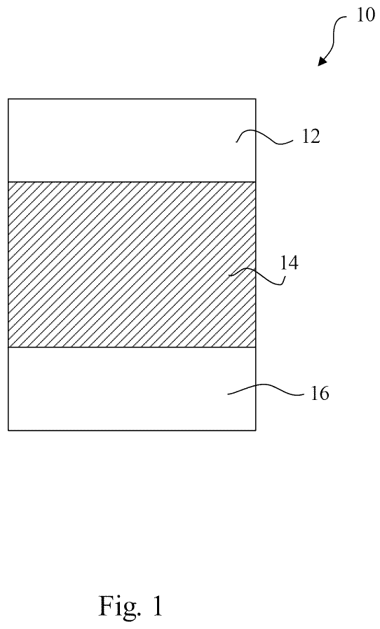

FIG. 1 is a diagram schematically showing a lithium-oxygen primary battery according to one embodiment of the present invention. The lithium-oxygen primary battery of the present invention is essentially similar to the conventional lithium-oxygen secondary battery. However, the lithium-oxygen primary battery of the present invention is different from the conventional lithium-oxygen secondary battery in that the electrolyte of the lithium-oxygen primary battery of the present invention is free of any catalyst, and the amount of lithium metal on the negative electrode is decreased. Because the lithium-oxygen primary battery of the present invention is exempted from using any catalyst and uses less lithium metal, the cost of the lithium-oxygen primary battery of the present invention is greatly reduced.

In order to the convenience of illustration, FIG. 1 neglects many parts of a lithium-oxygen primary battery 10 but only shows a positive electrode 12 (or called the cathode), a catalyst-free electrolyte 14, and a negative electrode 16 (or called the anode) thereof. The positive electrode 12 includes a porous electrically-conductive carbon material and a polymeric adhesive agent, wherein the porous electrically-conductive carbon material may be but is not limited to be carbon nanotubes. The negative electrode 16 includes lithium metal. The N/P ratio of the lithium-oxygen primary battery 10 may be but is not limited to 1-2. The catalyst-free electrolyte 14 is disposed between the positive electrode 12 and the negative electrode 16. The catalyst-free electrolyte 14 may be but is not limited to the solution of a lithium salt and an ether-group solvent.

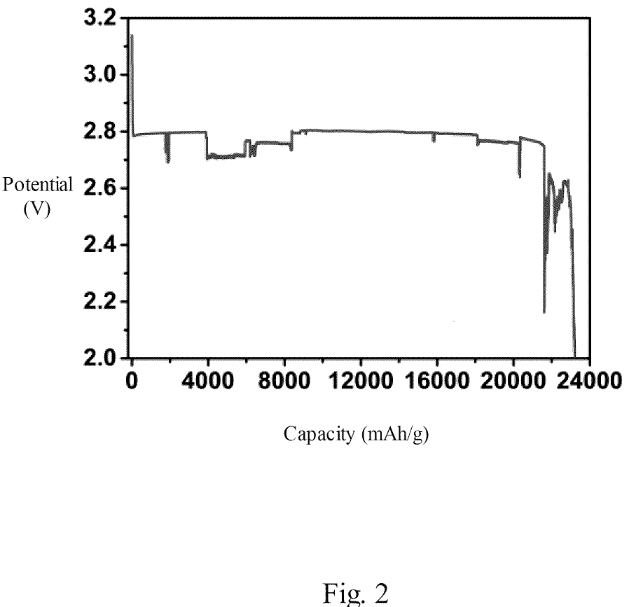

FIG. 2 shows the results of the electrochemical experiments of the lithium-oxygen primary battery shown in FIG. 1, wherein the current density of the lithium-oxygen primary battery is 100 mA/g. As shown in FIG. 2, the capacity of the lithium-oxygen primary battery 10 is greater than 20000 mAh/g, which is much higher than that of the existing lithium-oxygen secondary battery (about 1000-2000 mAh/g). In other words, the gravimetric energy density of the lithium-oxygen primary battery 10 is far larger than that of the existing lithium-oxygen secondary battery.

There are many methods to fabricate the positive electrode 12 of the lithium-oxygen primary battery 10 of the present invention, including the method described below: mixing a porous electrically-conductive carbon material and a polymeric adhesive agent by a ratio of 9:1 to form a powder mixture; placing the powder mixture into a container, and adding N-methyl-2-pyrrolidone (NMP) into the container to make powder mixture to form a slurry, whose weight percent of solid is 25%; fully stirring the slurry for one hour; using a coating rod to coat the slurry on a carbon paper; placing the carbon paper in an oven and baking the carbon paper to a temperature of 80° C. for one hour to remove most NMP solvent; placing the baked carbon paper in a vacuum oven and baking the baked carbon paper to a temperature of 80° C. overnight to obtain the positive electrode 12 of the lithium-oxygen primary battery 10. However, the present invention is not limited to only adopting the abovementioned method.

In one embodiment, the method of fabricating the catalyst-free electrolyte 14 includes steps: preparing a 1.0 M solution of a lithium salt and an ether-based solvent in anhydrous environment to form the catalyst-free electrolyte 14, wherein M is the molarity.

The present invention has been described with the embodiments. However, these embodiments are only to exemplify the present invention, not to limit the scope of the present invention. Any equivalent modification or variation made by the persons skilled in the art according to the technical spirit of the present invention is to be also included in the scope of the present invention.

What is claimed is:

1. A lithium-oxygen primary battery comprising:
a positive electrode;
a negative electrode; and
a catalyst-free electrolyte, disposed between the positive electrode and the negative electrode.

2. The lithium-oxygen primary battery according to claim 1, wherein the positive electrode comprises a porous electrically-conductive carbon material and a polymeric adhesive agent.

3. The lithium-oxygen primary battery according to claim 2, wherein the porous electrically-conductive carbon material comprises a carbon nanotube.

4. The lithium-oxygen primary battery according to claim 1, wherein the negative electrode comprises a lithium metal.

5. The lithium-oxygen primary battery according to claim 1, wherein the catalyst-free electrolyte comprises a lithium salt and an ether-group solvent.

6. The lithium-oxygen primary battery according to claim 1, wherein an N/P (Negative/Positive) ratio of the lithium-oxygen primary battery is 1-2.

7. The lithium-oxygen primary battery according to claim 1, wherein the lithium-oxygen primary battery has a capacity greater than 20000 mAh/g.
